(19) United States
(12) Patent Application Publication
(10) Pub. No.: US 2003/0063111 A1
(43) Pub. Date: Apr. 3, 2003

(54) Method and system for computing demurrage charges in private rail site

(75) Inventors: Robert D. Maclean, Iona (CA); John S. Huibers, Ottawa (CA)

Correspondence Address: Gregory A. Sebald, Merchant & Gould. P.C., Post Office Box 2903, Minneiapolis, MN, 55402-0903, US

(73) Assignee: CANAC INC.

(21) Appl. No.: 09/968,594

(22) Filed: Oct. 1, 2001

(51) Int. Cl. G06F 7/00

(52) U.S. Cl. 345/700

(57) ABSTRACT

A method and system for computing demurrage charges for a private railway site is provided. Information is delivered to a user for prompting him to enter demurrage charge computation parameters. The user enters the demurrage charge computation parameters via a computer interface. In response to the user providing the demurrage charge computation parameters, a database of railcar events is searched based on the demurrage charge computation parameters to derive a set of railcar entries. A charge policy is applied to the set of railcar entries to generate at least one data element indicative of a demurrage charge. The demurrage charge is then displayed to the user.

### FIELD OF THE INVENTION

This invention relates to a system and method for facilitating the management of railcars in a private railway site such as a plant, a private switching yard or an industrial complex. More particularly, this invention relates to a computer system for computing demurrage charges in a private railway site.

### BACKGROUND OF THE INVENTION

In large private railway sites, such as industrial plants, thousands of railcars enter and exit the private railway sites in a given period of time. In order to manage this volume of traffic, computer based railcar management systems have been developed.

Railway companies are frequently the owners of the railcars that enter and exit these private railway sites. In the majority of cases, the railroad that delivers the railcar to the private site levy demurrage charges when the railcars remain in a private railway site for a significant period of time. In essence, these charges are to discourage the private railway site operator from holding a railcar at a private railway site for a long period of time leaving the railcar inactive and not generating revenues for the owner of the railcar. Demurrage charges can be of the order of fifty to a hundred dollars per railcar, per day, while the railcar remains in the private railway site. Frequently, due to these sizeable charges that are levied, private railway site operators often dispute the amounts of the demurrage charge that are billed to them by the railroad that delivers the railcar to the private site.

A deficiency with known computer based railcar management systems is that they provide no suitable solution for the computation of demurrage charges in private railway sites.

Consequently there exists a need in the industry to provide an improved system and method for the computation of demurrage charges for a private railway site that alleviates at least in part the deficiencies of prior art systems and methods.

### SUMMARY

In accordance with a broad aspect, the invention provides a method for computing demurrage charges in private railway sites. The method includes delivering information to a user for prompting the user to enter demurrage charge computation parameters. In response to the user providing the demurrage charge computation parameters, a database of railcar events is searched based on the demurrage charge computation parameters to derive a set of railcar entries. A charge policy is applied to the set of railcar entries to generate at least one data element indicative of a demurrage charge. The data element indicative of the demurrage charge is then displayed to the user.

In accordance with a specific implementation, the information prompting the user to enter demurrage charge computation parameters is displayed on a screen in the form of a user interface. The user provides the demurrage charge computation parameters through an input device such as a keyboard, pointing device, touch sensitive surface or speaker combined with a speech recognition unit.

An advantage of the present invention is that it allows a user at a private operator railway site to compute demurrage charges that should be levied by the railroad having delivered the railcars to the private site on the basis of a set of parameters provided by the user.

In accordance with a non-limiting implementation, the demurrage charge computation parameters include a time indicator data element, a railroad identifier and a railcar type identifier. The time indicator data element specifies for what time period the demurrage charge is to be computed. The railroad identifier is associated to a railroad having delivered the railcar and specifies for which railroad the demurrage charge is to be computed. The railcar type identifier specifies for which railcar type the demurrage charge is to be computed. Each of these parameters may be used alone or in combination with other parameters to compute the demurrage charge without detracting from the spirit of the invention. For example, the user may specify that he/she requires the demurrage charges for the month of July 2001. Alternatively, the user may specify that he/she requires the demurrage charges for the month of July 2001 for railcars of type “GONDOLA CAR” brought into the private rail site by a railroad belonging to the Canadian National Railway Company. Other useful parameters include a loading/unloading indicator, a product type indicator and a leased/non-leased indicator data element. Additional parameters may be provided without detracting from the spirit of the invention.

In a non-limiting implementation, the charge policy includes selecting a charge policy from a plurality of charge policies on the basis of railcar characteristics. In a specific example, the charge policy used is selecting from a plurality of charge policies on the basis of the railroad identifier. Advantageously, this permits each railroad that delivers the car to define a respective set of policies for the computation of the demurrage charge such as, for example, the cost per railcar type per day and the number of days of credit where no demurrage charges are levied amongst others. Other policies including incremental values for excess time may also be provided such as 50$/day for 4-10 days, 75$/day for 11 days and more. It will be readily apparent that many variants on the charge policies are possible and the invention is not limited to the specific charge policy being used. The charge policy may also include credits in the form of days where the private railway site is given a credit a railcar exiting the private railway site prior to a certain threshold period.

In a specific implementation, the database of railcar events includes a plurality of records, each record being associated to a respective railcar, each record including a plurality of entries associated to the railcar allowing searching records on the basis of the demurrage charge computation parameters. Each record includes at least one entry selected from the set consisting of a time indicator data element, a railroad identifier and a railcar type identifier. In a non-limiting implementation, each record includes at least one time indicator data element indicative of time of entrance of the associated railcar in the private railway site and at least some records include an indicator data element indicative of time of exit of the associated railcar in the private railway site. In a non-limiting implementation, other entries such as a loaded/unloaded status indicator, a product type indicator and a leased/non-leased indicator may also be included in the record. Additional entries may be provided without detracting from the spirit of the invention.

In accordance with another broad aspect, the invention provides a computer readable medium including a program element executable by a computing apparatus for implementing the above described method.

In accordance with a broad aspect, the invention provides a system implementing the above-described method. In a non-limiting implementation, the system includes a computer and a server machine. The server machine includes a processor and a computer readable storage medium storing a program element implementing the above-described method when executed in the processor. The computer constitutes a client machine in a network arrangement with the server machine. The client machine runs a browser program element. The program element executing at the server machine exchanges messages with the browser of the client machine and causes the browser to display the data element indicative of the demurrage charge to the user.

In accordance with another aspect, the invention provides a browser suitable for execution on a user computer. The browser displays a user interface including input controls for specifying demurrage charge computation parameters. In response to the user providing the demurrage charge computation parameters with the input controls, the browser transmits a signal to a server system conveying the demurrage charge computation parameters. In response to receiving a message from the server system including demurrage charge results, the browser displays a user interface to the user including demurrage charge results.

In a specific implementation, the input controls for specifying demurrage charge computation parameters include input controls for specifying a time indicator data element, a railroad identifier and railcar type identifier.

In a specific implementation, the user provides the demurrage charge computation parameters through an input device such as a keyboard, pointing device, touch sensitive surface and a speech recognition unit.

In accordance with another aspect, the invention provides a method for providing a user with railcar delay report in a private railway site. Information is delivered to a user for prompting the user to enter delay selection parameters. A database of railcar events is searched to derive a set of railcar identifiers associated to railcars currently in the private railway site. In response to the user providing the delay selection parameters, a subset of railcars is selected from the set of railcars currently in the private railway site on the basis of the delay selection parameters provided by the user. The railcar identifiers corresponding to the selected subset of railcar are then displayed to the user.

In a non-limiting example, wherein the delay selection parameters include a demurrage charge amount. In this example, a demurrage charge policy is applied to each railcar currently in the private railway site to derive a demurrage charge data element for each railcar currently in the private railway site. In response to the user providing the delay selection parameters, a subset of railcars is selected from the set of railcars currently in the private railway site at least in part on the basis of the computed demurrage charge data elements and the demurrage charge amount provided by the user.

An advantage of the present invention is that it allows a user at a private operator railway site to view the railcar identifiers of the railcars that are being delayed in the private railway site and that are consequently incurring demurrage charges. For example, if a railcar has been in the private railway site for a prolonged period of time, while being unnoticed by the site operator, significant demurrage charges are being accumulated on that railcar. The present system allows specifying delay selection parameters such as duration of stay in the private railway site and demurrage charge amount incurred to date. On the basis of this information, the system locates railcars that have been in the private railway site for a period of time exceeding a certain threshold or that have incurred demurrage charge exceeding a certain threshold and brings them to the attention of the user at the operator site. This may allow the user to take the necessary steps to avoid these railcars being in the private railway site for an extended period of time.

In accordance with another broad aspect, the invention provides a computer readable medium including a program element executable by a computing apparatus for implementing the above described method.

In accordance with a broad aspect, the invention provides a system implementing the above-described method.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a block diagram of a network-based system for computing demurrage charges including a server machine and individual computers interconnected through a network in accordance with an embodiment of the invention;

FIG. 2 is a block diagram of an individual computer of FIG. 1 in accordance with an embodiment of the invention;

FIG. 3 is a detailed block diagram of the server machine of FIG. 1 in accordance with a non-limiting implementation of the invention;

FIG. 4 is a schematic diagram of the program element implemented by the server machine of FIG. 1 in accordance with a non-limiting implementation of the invention;

FIG. 5 is a non-limiting example of implementation of a user interface for prompting the user to enter demurrage charge computation parameters;

FIG. 6 is a non-limiting example of implementation of a user interface for prompting the user to enter delay selection parameters.

FIG. 7 to 9 show specific implementation of a graphical user interface for prompting the user to enter demurrage charge computation parameters and for displaying demurrage charge results.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

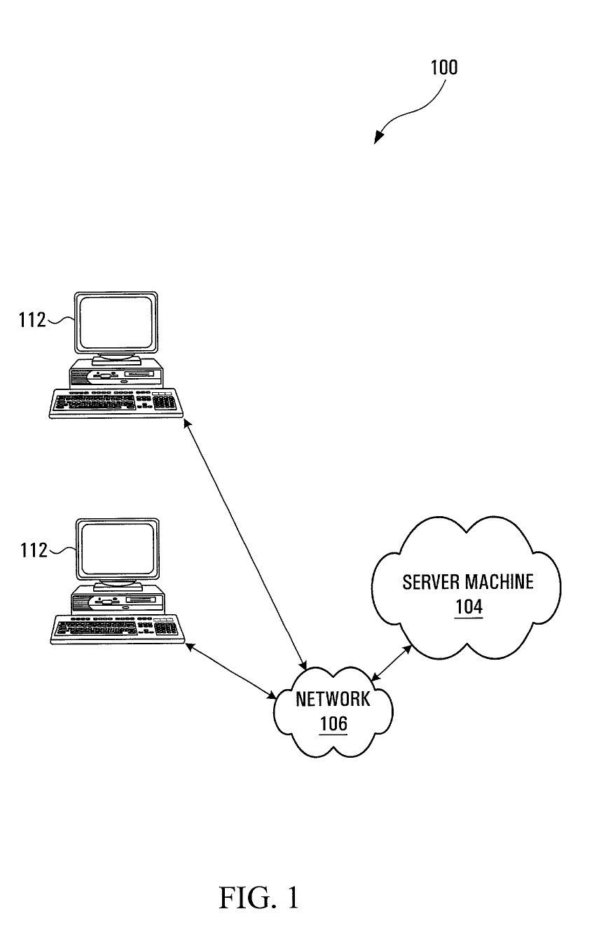

FIG. 1 illustrates a network-based system for computing demurrage charges 100 in accordance with a specific implementation. The system 100 includes a plurality of client machines in the form of individual computers 112 connected to a server machine 104 through a network 106. The communication links between the computers 112, the server machine 104 and network 106 can be metallic conductors, optical fibers or wireless, without departing from the spirit of the invention.

The network 106 is a data communication network interconnecting the computers 112 and the server machine 104. In a specific example of implementation, the network is a public network. In the illustrated implementation, the data communication network 106 is embodied in the Internet. It is to be noted that the data communication network 106 may be implemented as a network other that the Internet such as an interactive television (ITV) network, a private network such as an Intranet or any other suitable network.

The individual computers 112 are generally in the form of personal computers, although other types of computing units may be used including laptops, notebooks, hand-held computers, set top boxes, and the likes. The individual computers 112 may be connected to one another over an Intranet or may be stand-alone computing units. Each of the individual computers 112 is provided with a connection to the network 106. The connection may be a permanent connection through a server at the customer's premises, or alternatively, a given individual computer may occasionally connect to the network 106 through the use of a dial-up connection using suitable devices such as a modem for example.

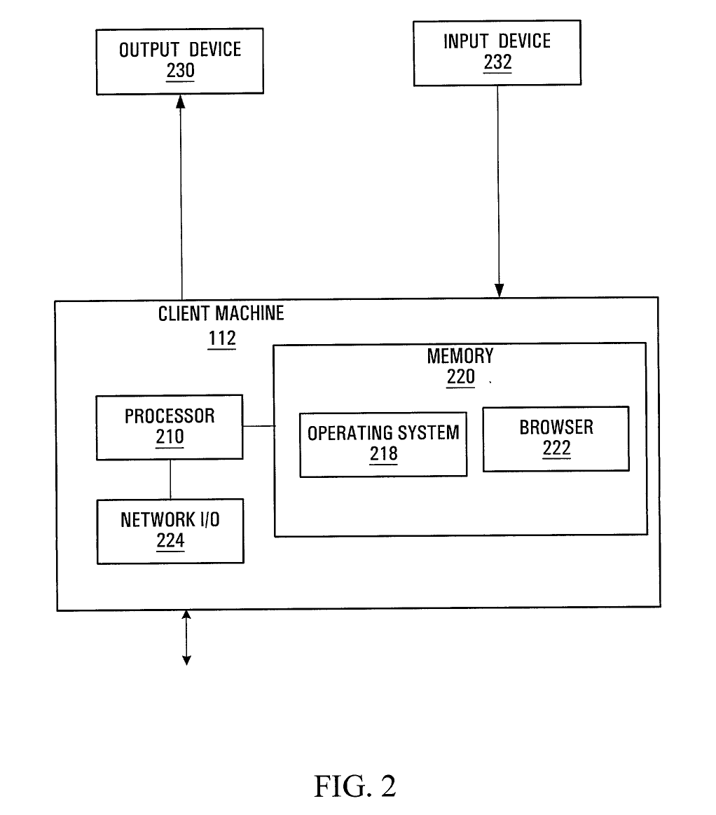

FIG. 2 is a block diagram of individual computer 112. As shown, the computer 112 comprises a processor 210 connection to a memory 220. Although the memory 220 is shown as a single block, it may include a plurality of separate components, such as floppy disk drive, a fixed disk and Random Access Memory (RAM), among others. The computer 112 also includes a network I/O 224 (input/output) for accessing the network 106. The network I/0 224 is the entity through which the individual computer 112 communicates with other entities of the system 100. For instance, data sent from or received by computer 112, during a communication session with the server machine 104 or any other computer 112 transits through the network I/O 224. The network I/0 224 can be implemented, for example, as a dial-up modem or as a permanent network connection. The computer 112 also includes an output device 230 to communicate information to a user. In the example shown, the output device 230 includes a display. Optionally, the output device 230 includes a loudspeaker. The computer 112 further includes an input device 232 through which a user at the computer 112 may input data. The input device 232 includes any one or a combination of the following: keyboard, pointing device, touch sensitive surface or speech recognition unit. The processor 210 is adapted to execute program elements stored in the memory 220 for performing certain functions. More specifically, the computer 112 runs an operating system 218 that supports multiple applications. The operating system 218 is preferably a multitasking operating system that allows simultaneous execution of multiple applications in a graphical windowing environment. The memory 220 also includes a browser program element 222. The browser program element 222 when launched is executed by the processor 210 atop the operating system 218. The individual computers 112 may also include additional components and modules. These have been omitted from the description for the purpose of clarity. When the computer 112 is in use, the memory 220 holds software executed by the processor 210 to implement browser 222. It is through this browser 222 that that the user can receive information sent by the server machine 104 and it can in turn deliver information to the server machine 104. The communication between the computer 112 and the server machine 104 can be effected on the basis of any suitable protocol, such as HyperText Transfer Protocol (HTTP).

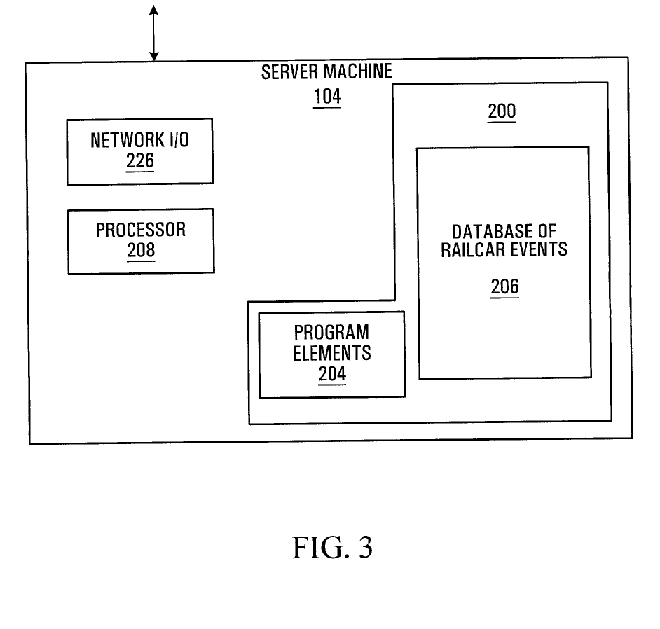

The server machine 104 includes one or more computer servers and one or more computing apparatuses. The structure of the server machine 104 is similar to the structure of the computer 112. The main difference resides in the software that is executed by the processor of the server machine 104 which gives the server machine 104 a different functionality than the functionality of the computer 112. FIG. 3 is a block diagram of the server machine 104. As depicted, the server machine 104 comprises a processor 208, a memory 200 and a network I/O 226 (input/output) for connection to the network 106. The network I/O 226 is preferably implemented as a permanent network connection although dial up connections may be suitable in certain embodiments. The processor 208 is adapted to execute program elements 204 stored in the memory 200 for performing various functions. The memory 200 also has a data portion 206 including a database of railcar events 202. It will be readily appreciated that the server machine 104 may include additional components and modules. These have been omitted from the description for the purpose of clarity.

In this specific example, the database of railcar events 206 includes a plurality of records, each record being associated to a respective railcar. Each record includes a plurality of entries including data elements describing characteristics associated to a given railcar, notably: a railcar owner, a railcar identifier, a railcar type identifier, the arrival time of the railcar at the private railway site, the exit time of the railcar at the private railway site, a loaded/unloaded indicator, a product type indicator, a leased/non-leased indicator data element and any other information that may be useful. It will be readily observed that certain characteristics may be omitted from a given railcar record and addition characteristics may be added without detracting from the spirit of the invention. For example, for a railcar still located in the private railway site, there will notbe an exit time entry corresponding to an arrival time entry for that railcar. It will also be appreciated that a given railcar record may have several data elements indicative of arrival times and exit times of the railcar at the private railway site in the case where a railcar enters and exits a rail site repeatedly. It is to be expressly understood that other formats for a database of railcar events 206 are possible without detracting from the spirit of the invention.

As a variant, the database of railcar events 206 may include railcar events for multiple private railway sites. In such cases, only the railcar events associated to the private railway site corresponding to the user of the demurrage charge computing system are used.

The entries for a given railcar are received by the network I/O interface 226 of the server machine 104 and stored in the database of railcar events 206 in association with the private railway site and the railcar. The entries may be provided via electronic feeds from the railcars (such as by the use of transponders), by a user via a computer terminal in communication with the server machine 104 or by any other suitable device.

From a functional perspective, the program element 204 executed by the processor 208 of the server machine 104 can be divided in several components. The components differ from one another primarily by the information they deliver, capture or process, not necessarily by the way the actual code is being organized.

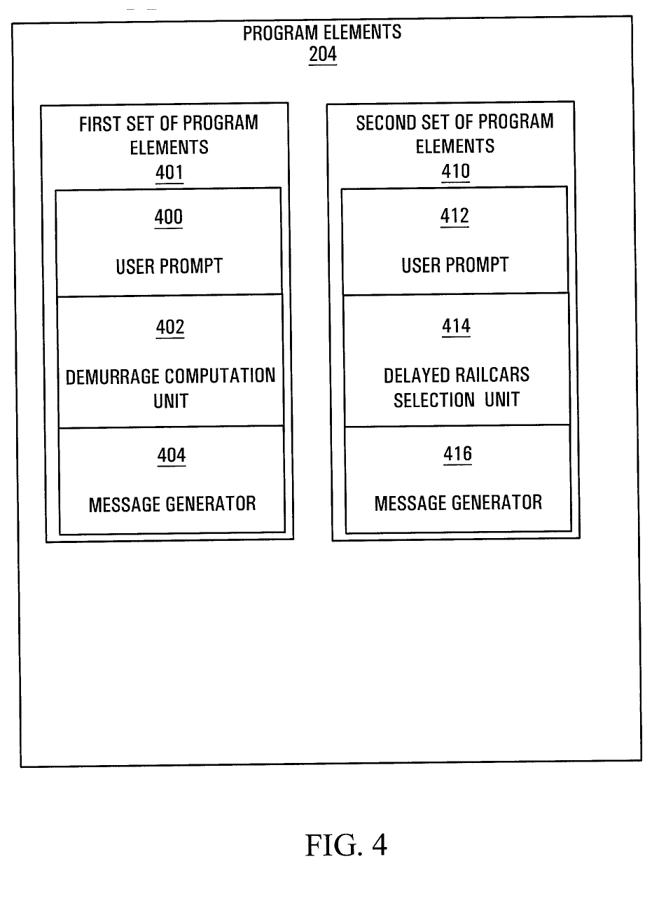

A block diagram of the architecture of the program element is shown in FIG. 4. The program element can be divided into two sets of program elements components 401 410. The first set of program element components 401 implements the functionality related to the computation of demurrage charges and the display of the demurrage charge results to the user. The second set of program element components 410 implements the functionality related to the extraction of a list of railcars and the display a delayed railcar report to the user.

The First Set of Program Elements 401

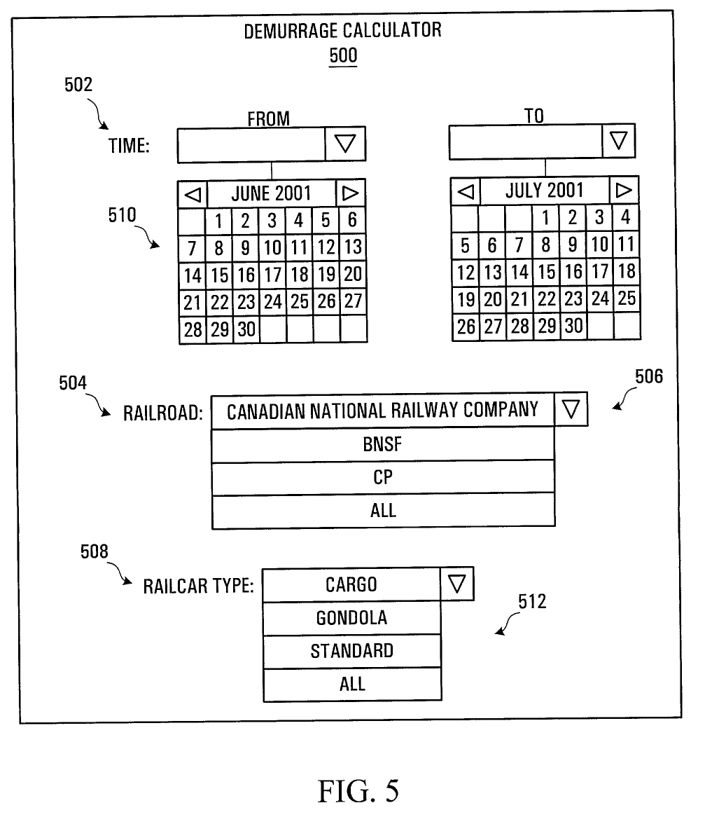

The first set of program element components 401 implements the functionality related to the computation of demurrage charges and the display of the demurrage charge results to the user. A first program element component 400 prompts the user at the computer 112 to enter at the computer demurrage charge computation parameters. In this example of implementation the information is delivered to the user at the computer 112 visually, through a user interface 500 shown at FIG. 5. The first program element component 400, executing on the server machine 104, sends messages to the computer 112, over the communication link between the server machine 104 and the computer 112. The browser on the computer 112 uses those messages to present to the user the information via the user interface 500. When information is to be sent from the computer 112 to the server machine 104, the browser on the computer 112 sends messages with the information over the communication link to the server machine 104 that processes the information as required. The user interface includes input controls for specifying demurrage charge computation parameters. In this specific example, the input controls include input control for specifying a time indicator data element 502, a railroad identifier 504 and railcar type identifier 508. Although the example depicted in FIG. 5 shows three demurrage charge computation parameters, other useful parameters may be added without detracting from the spirit of the invention.

To facilitate the information entry by the user, assists can be provided. An example of such an assist is to present to the user a list of options for a selection. Any suitable input control assist may be used for specifying the demurrage charge computation parameters such as text boxes, pull-down menus and selection buttons amongst others. In a non-limiting implementation, the input control for specifying a time indicator data element 502 is in the form of a pull-down calendar 510 allowing a user to specify a beginning date and an end date, a month or any other suitable time period. The input control for specifying the railroad identifier is in the form of a list of railroad identifiers or pull-down menu 506 allowing a user to select one or more railroad identifiers. The input control for specifying a railcar type identifier is in the form of a list of railcar type identifiers 512 or a pull-down menu allowing the user to select any one or more of those identifiers as input. It will be readily appreciated that other suitable input controls may be used without detracting from the spirit of the invention. Another example of an assist is a search engine that receives a keyword and searches a database of identifiers to return all elements matching the keyword. The user can then make a selection among the list of matches.

The prompting performed by the first program element component 400 can be active or passive. In the case of a passive prompting the user is presented with a control where information can be entered through the input device 232 of the computer 112. The active prompting includes in addition to just presenting the control where the information can be entered, the performance of some other action positively urging the user to supply the information. One example is to present a dialog box with a message to draw the attention of the user, playing an audible message, among many others.

The time indicator data element 502 may explicitly describe a time period by including a start time and an end time or, alternative may implicitly describe a time period. A first example of implicit time indicator data element includes providing a month for which the demurrage charge is to be computed. A second example of implicit time indicator data element includes providing a start date without specifying an end date for which the demurrage charge is to be computed. In this second example, the end date may be taken as being the current date. A third example of implicit time indicator data element includes providing an end date for which the demurrage charge is to be computed. In this third example, the start date may be taken as being the earliest date for which railcar events are available in the database. Many other ways of providing a time indicator data element describing a time period may also be used and will be readily apparent to those skilled in the art in light of this specification.

Each of the demurrage charge computation parameters may be used alone or in combination without detracting from the spirit of the invention. For example, the user may specify that he/she requires the demurrage charges for the month of July 2001 and leave blank the railroad identifier and railcar type identifier. In a non-limiting implementation, this would indicate that the user wishes to obtain the demurrage charges for the month of July 2001 for all railroads through which railcars have entered the private site and for all railcar types. Alternatively, the user may specify that he/she requires the demurrage charges for the month of July 2001 for railcars of type “GONDOLA CAR” brought into the private rail site by a railroad belonging to the Canadian National Railway Company.

The user supplies the demurrage charge computation parameters through the input device 232.

The exchange of information between the user at the computer 112 and the server machine 104 is done by the transmittal of messages between the server machine 104 and the computer 112 through network 106.

The program element 204 executed by the processor 208 of the server machine 104 includes a second program element component 402. The second program element component 402 receives from the first program element component 400 the demurrage charge computation parameters entered by the user and calculates demurrage charges.

In a first step, the second program element component 402 searches the database of railcar events 206 to locate railcar events matching the demurrage charge computation parameters.

In a non-limiting implementation, for each record in the database of railcar events 206, the entries are compared to the demurrage charge computation parameters. Following this, the number of consecutive days that a railcar satisfies the demurrage charge computation parameters is generated. If a railcar has been in the private railway site more than once, the number of consecutive days that the railcar satisfies the demurrage charge computation parameters is generated separately for each time that the railcar was in the private railway site. Locating a list of entries in a database satisfying a set of criteria may be effected using any suitable method and the invention is not limited by the specific method used to generate locate the list of entries in a database 206 satisfying the demurrage charge computation parameters. The result is a list of railcar entries, each railcar entry in the list including a railcar identifier, a railcar type, a railroad identifier and a number of consecutive days the railcar satisfied the demurrage charge computation parameters. Table 1 shows a nonlimiting example of the list of railcar entries generated by the second program element.

TABLE 1

| Railcar | | Railroad | Number Of |
|---|---|---|---|
| Identifier | Railcar Type | Identifier | Consecutive Days |
| REF36 | GONDOLA CAR | CN | 15 |
| REF36 | GONDOLA CAR | CN | 2 |
| ABC12 | STANDARD | CP | 10 |
| FGE | STANDARD | BNSF | 9 |

In a second step, the second program element component 402 applies a charge policy to each railcar entry in the list of railcar entries to generate a demurrage charge. Any suitable charge policy may be used to generate the demurrage charge application to each railcar. Typically, the railroad specifies the demurrage charge policy for the railcars it brings into a private railway site. The charge policy applicable to a given railcar is selected from a plurality of charge policies on the basis of the railroad identifier. Each railroad may define a respective set of policy for the computation of the demurrage charge such as, for example, the cost per railcar type per day, the number of days where no demurrage charges are levied. Other policies including incremental values for excess time may also be provided such as 0$/day (or alternatively a credit of X$/day) for the first 3 days, 100$/day for 4-10 days, 200$/day for 11 days and more.

Alternatively, when a same charge policy can be applied to a set of railcars, the sum of the days for all cars may be used in computing the demurrage charge. This allows days of credit where no demurrage charges are applicable to be shared between several railcars. For example, in table 1 let us take the case where a same charge policy applies to each railcar. This charge indicates that each railcar is given a credit of 3 days during which no demurrage charges are applied and there are 4 railcars. In this case, a total of 12 days of credit are available. These 12 days can be deducted from the total of 36 days (15+2+10+9=36) leasing 24 days on which the demurrage charges are to be computed.

It will be readily apparent that many other variants on the charge policies are possible and the invention is not limited to the specific charge policy being used. Once a demurrage charge is generated for each railcar, a total demurrage charge is generated on the basis of the demurrage charges per railcar.

The program element 204 executed by the processor 208 of the server machine 104 includes a third program element component 404 include a message generator that receives from the second program element component 402 the data element indicative of a demurrage charge and sends a message including at least one data element indicative of a demurrage charge to the computer 112. For the purpose of this specification “message” should be interpreted in a broad sense and refers to the substance of the communication without any limitation as to the physical medium or protocol used to transmit the message. The third program element component displays to the user the data element indicative of the demurrage charge. In this example of implementation the demurrage charge is delivered to the user at the computer 112 visually, through a user interface.

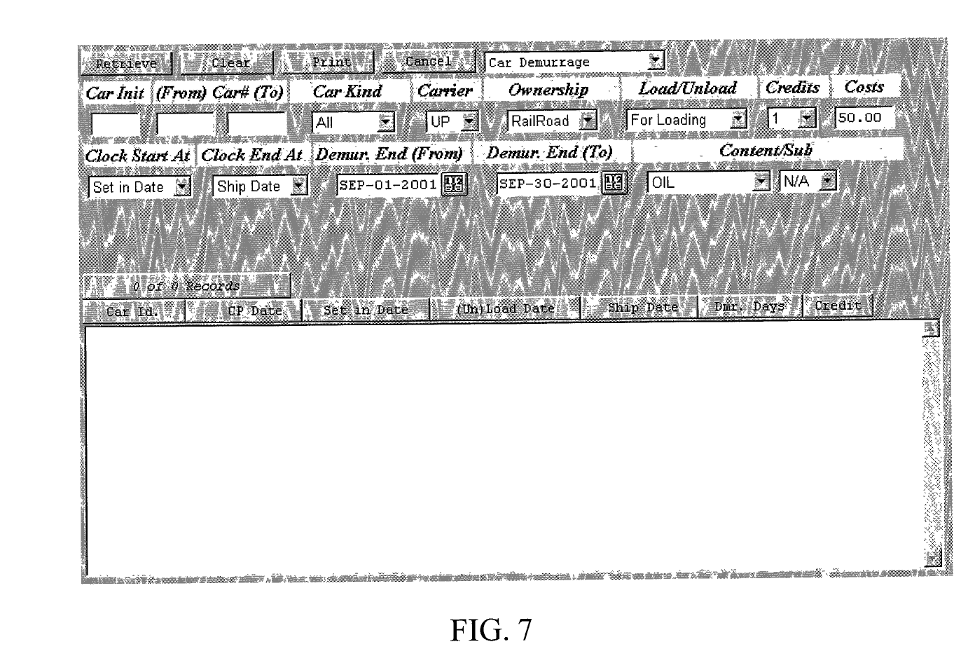

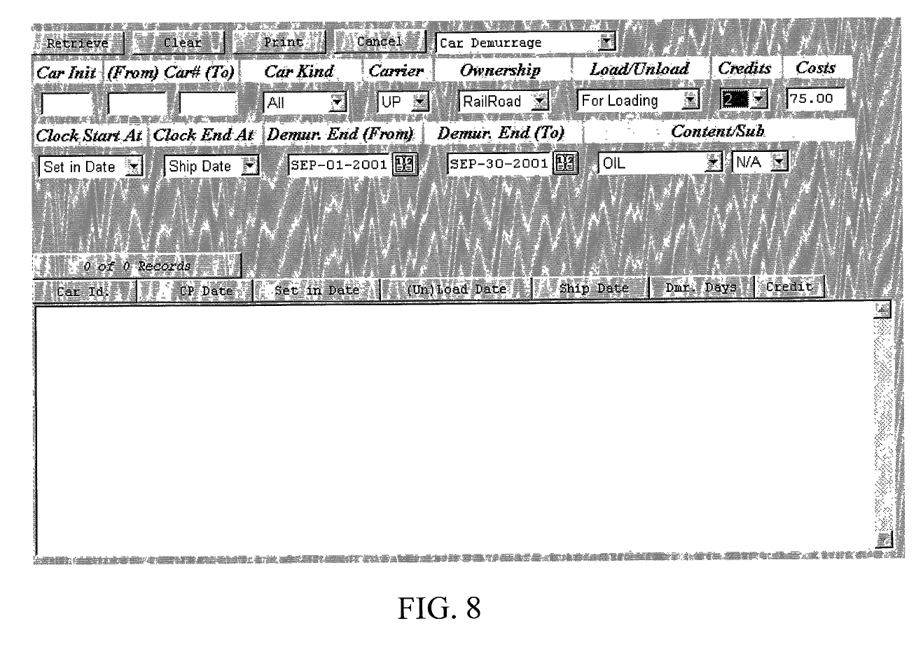

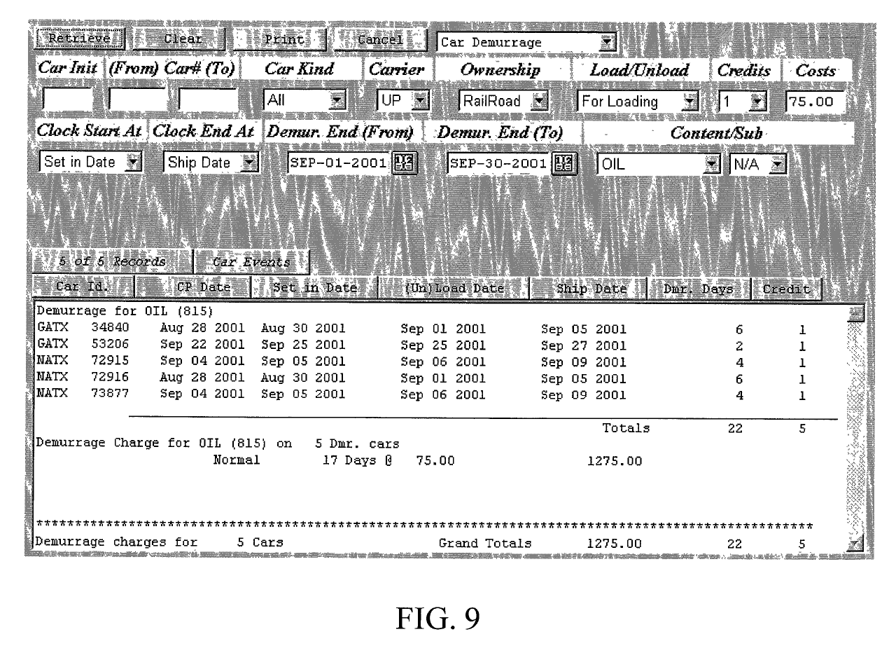

FIGS. 7 to 9 show a specific non-limiting implementation of a graphical user interface for prompting a user to enter demurrage charge parameters and for displaying demurrage charge results to a user. It will be readily appreciated that other implementations for the graphical user interface are possible without detracting from the spirit of the invention.

The Second Set of Program Elements 410

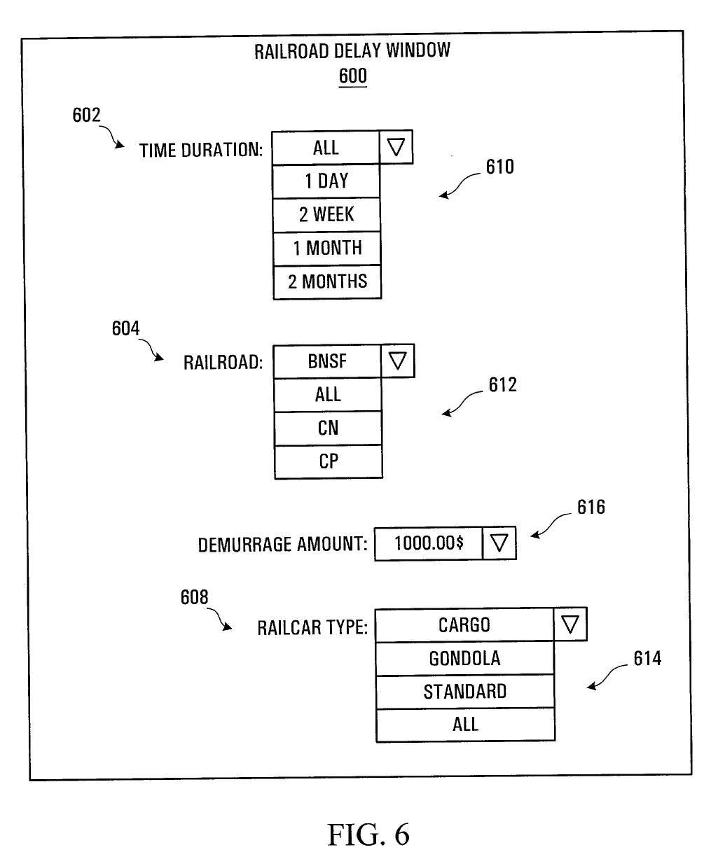

The second set of program element components 410 implements the functionality related to the extraction of a list of railcars and the display a delayed railcar report to the user. The second set of program element components 410 includes a first component 412 for prompting the user at the computer 112 to enter delay selection parameters. In this example of implementation the information is delivered to the user at the computer 112 visually, through a user interface 600 shown at FIG. 6. The first program element component 412, executing on the server machine 104, sends messages to the computer 112, over the communication link between the server machine 104 and the computer 112. The browser on the computer 112 uses those messages to present to the user the information via the user interface 600. When information is to be sent from the computer 112 to the server machine 104, the browser on the computer 112 sends messages with the information over the communication link to the server machine 104 that processes the information as required. The user interface includes input controls for specifying delay selection parameters. In this specific example, the input controls include input control for specifying a time duration data element 602, a railroad identifier 604, demurrage charge amount 605 and railcar type identifier 608. Although the example depicted in FIG. 6 shows four delay selection parameters, it will be readily apparent that certain parameters may be omitted for specific implementation and that other useful parameters may be added without detracting from the spirit of the invention.

In order to facilitate the information entry by the user, assists can be provided. Any suitable input control assist may be used for specifying the delay selection parameters such as text boxes, pull-down menus and selection buttons amongst others. In a non-limiting implementation, the input control for specifying a time duration data element 602 is in the form of a pull-down menu 610 including time duration in terms of days, weeks and months or any other suitable time period. The input control for specifying the railroad identifier 604 is in the form of a list of railroad identifiers or pull-down menu 612 allowing a user to select one or more railroad identifiers. The input control for specifying a railcar type identifier 608 is in the form of a list of railcar type identifiers or a pull-down menu 614 allowing the user to select any one or more of those identifiers as input. The input control for specifying a demurrage charge amount 605 is in the form of a text box allowing the user to enter a demurrage charge amount or range of amounts as input. Each of the delay selection parameters may be used alone or in combination without detracting from the spirit of the invention.

The prompting performed by the first program element component 412 can be active or passive. In the case of a passive prompting the user is presented with a control where information can be entered through the input device 232 of the computer 112. The active prompting includes in addition to just presenting the control where the information can be entered, the performance of some other action positively urging the user to supply the information. One example is to present a dialog box with a message to draw the attention of the user, playing an audible message, among many others.

The user supplies the delay selection parameters through the input device 232.

The exchange of information between the user at the computer 112 and the server machine 104 is done by the transmittal of messages through network 106 between the server machine 104 and the computer 112.

The program element 204 executed by the processor 208 of the server machine 104 includes a second program element component 414. The second program element component 414 receives from the first program element component 412 the delay selection parameters entered by the user.

In a first step, the second program element component 414 searches the database of railcar events 206 to derive a set of railcar identifiers associated to railcars currently in the private railway site. In this specific example, this may be done by locating in the database of railcar events 206 records where an the arrival time data element with no corresponding exit time data element indicating that the railcar still remains in the private railway site.

In a second step, second program element component 414 selects a subset of railcars from the set of railcars currently in the private railway site on the basis of the delay selection parameters provided by the user. For example, if the delay selection parameters indicate to locate all the railcars that have been in the private site in excess of 2 weeks, the second program element component 414 will search the records in the database of railcar events to locate the railcars satisfying this selection parameter. Similar searches may be effected on the basis of railcar type and railroad identifiers.

In a non-limiting implementation, the delay selection parameter may include a demurrage charge amount where the user wishes to obtain a list of all railcars having accumulated demurrage charges exceeding a certain demurrage charge amount. In response to the user providing a demurrage charge amount, the second program element component 414 applies a charge policy to the railcars currently in the private railway site to derive a set of demurrage charge data elements, each demurrage charge data element being associated to a respective railcar currently in the private railway site. A subset of railcars is selected from the set of railcars currently in the private railway site on the basis of the set demurrage charge data elements and the demurrage charge amount provided by the user. In a non-limiting example, the demurrage charge amount provided by the user acts as a threshold whereby all railcars having accumulate a demurrage charge amount exceeding the threshold are selected for transmission to the user.

The program element 204 executed by the processor 208 of the server machine 104 includes a third program element component 416 including a message generator that receives from the second program element component 414 at least one data element indicative of a demurrage charge and sends to the computer 112 a message including railcar identifiers corresponding to the subset of railcars selected by the fifth program element component. The third program element component displays to the user the data element indicative of the subset of railcar identifiers. In this example of implementation the subset of railcar identifiers is delivered to the user at the computer 112 visually, through a user interface.

In one possible variant, the invention can be implemented on a stand-alone computer rather than on a network-based system. In this variant, the program element 204 reside locally in the storage medium of the computer and they are executed by the processor of the computer to interface with the user.

Although the present invention has been described in considerable detail with reference to certain preferred embodiments thereof, variations and refinements are possible without departing from the spirit of the invention. Therefore, only the appended claims and their equivalents should limit the scope of the invention.

1. A method for computing demurrage charges comprising:
a) delivering information to a user for prompting the user to enter demurrage charge computation parameters;
b) in response to the user providing the demurrage charge computation parameters, searching a database of railcar events based on the demurrage charge computation parameters to derive a set of railcar entries;
c) applying a charge policy to the set of railcar entries to generate at least one data element indicative of a demurrage charge;
d) displaying to the user the at least one data element indicative of the demurrage charge derived in c).

2. A method as defined in claim 1, wherein the delivering information to a user for prompting the user to enter demurrage charge computation parameters is done by displaying information on a screen.

3. A method as described in claim 2, wherein the demurrage charge computation parameters include a time indicator data element from which a time period for which the demurrage charge is to be computed can be derived.

4. A method as described in claim 2, wherein the demurrage charge computation parameters include a railroad identifier associated to a railroad for which the demurrage charge is to be computed.

5. A method as described in claim 2, wherein the demurrage charge computation parameters include a railcar type identifier for which the demurrage charge is to be computed.

6. A method as described in claim 2, wherein the demurrage charge computation parameters include one or more data elements selected from the set consisting of a time indicator data element, railroad identifier and a railcar type identifier.

7. A method as defined in claim 6, wherein the user provides the demurrage charge computation parameters through an input device selected from the group consisting of keyboard, pointing device, touch sensitive surface and speech recognition unit.

8. A method as defined in claim 2, wherein applying the charge policy includes selecting a charge policy from a plurality of charge policies on the basis of railcar characteristics.

9. A method as defined in claim 4, wherein applying the charge policy includes selecting a charge policy from a plurality of charge policies on the basis of the railroad identifier.

10. A method as defined in claim 1, wherein the database of railcar events includes a plurality of records, each record being associated to a respective railcar, each record including a plurality of entries associated to the railcar allowing searching records on the basis of the demurrage charge computation parameters.

11. A method as defined in claim 10, wherein each record includes at least one entry selected from the set consisting of a time indicator data element, a railroad identifier and a railcar type identifier.

12. A method as defined in claim 10, wherein each record includes at least one time indicator data element indicative of time of entrance of the associated railcar in the private railway site and at least some records include an indicator data element indicative of time of exit of the associated railcar in the private railway site.

13. A system for computing demurrage charges, said system comprising:
a) a computer;
b) a computer readable storage medium containing a program element for execution by a processor, said program element including:
i) a first program element component for causing said computer to display information to the user, the information prompting the user to enter demurrage charge computation parameters;
ii) a second program element component responsive to the user providing the demurrage charge computation parameters for:
(1) searching a database of railcar events based on the demurrage charge computation parameters to derive a set of railcar entries;
(2) applying a charge policy to the set of railcar entries to generate at least one data element indicative of a demurrage charge;
iii) a third program element component for displaying to the user the at least one data element indicative of the demurrage charge.

14. A system as defined in claim 13, said system comprising a server machine, said computer readable storage medium being located in said server machine, said server machine including a processor for executing said program element.

15. A system as defined in claim 14, wherein said computer constitutes a client machine, said client machine being in a network arrangement with said server machine.

16. A system as defined in claim 15, wherein said client machine is operative to run a browser program element.

17. A system as defined in claim 15, wherein said first, second and third program element components exchange messages with said browser and cause said browser to display said at least one data element indicative of the demurrage charge to the user.

18. A system as described in claim 15, wherein the demurrage charge computation parameters include a time indicator data element from which a time period for which the demurrage charge is to be computed can be derived.

19. A system as described in claim 15, wherein the demurrage charge computation parameters include a railroad identifier associated to a railroad for which the demurrage charge is to be computed.

20. A system as described in claim 15, wherein the demurrage charge computation parameters include a railcar type identifier for which the demurrage charge is to be computed.

21. A system as described in claim 15, wherein the demurrage charge computation parameters include one or more data elements selected from the set consisting of a time indicator data element, railroad identifier and a railcar type identifier.

22. A system as defined in claim 21, wherein computer includes an input device selected from the group consisting of keyboard, pointing device, touch sensitive surface and speech recognition unit suitable for allowing the user provides the demurrage charge computation parameters.

23. A system as defined in claim 15, wherein applying the charge policy includes selecting a charge policy from a plurality of charge policies on the basis of railcar characteristics.

24. A system as defined in claim 21, wherein applying the charge policy includes selecting a charge policy from a plurality of charge policies on the basis of the railroad identifier.

25. A system as defined in claim 13, wherein the database of railcar events includes a plurality of records, each record being associated to a respective railcar, each record including a plurality of entries associated to the railcar allowing searching records on the basis of the demurrage charge computation parameters.

26. A system as defined in claim 25, wherein each record includes at least one entry selected from the set consisting of a time indicator data element, a railroad identifier and a railcar type identifier.

27. A system as defined in claim 25, wherein each record includes at least one time indicator data element indicative of time of entrance of the associated railcar in the private railway site and at least some records include an indicator data element indicative of time of exit of the associated railcar in the private railway site.

28. A railcar management system facilitating the management of railcars in a private railway site including a system for computing demurrage charges as described in claim 13.

29. A computer readable storage medium containing a program element for execution by a processor, said program element comprising:
a) a first program element component for causing a computer to display information to a user, the information prompting the user to enter demurrage charge computation parameters;
b) a second program element component responsive to the user providing the demurrage charge computation parameters for:
(1) searching a database of railcar events based on the demurrage charge computation parameters to derive a set of railcar entries;
(2) applying a charge policy to the set of railcar entries to generate at least one data element indicative of a demurrage charge;
c) a third program element component for displaying to the user the at least one data element indicative of the demurrage charge.

30. A computer readable storage medium as defined in claim 28, wherein said first, second and third program element components exchange messages with a browser at the computer and cause said browser to display the at least one data element indicative of the demurrage charge to the user.

31. A computer readable storage medium as described in claim 28, wherein the demurrage charge computation parameters include a time indicator data element from which a time period for which the demurrage charge is to be computed can be derived.

32. A computer readable storage medium as described in claim 28, wherein the demurrage charge computation parameters include a railroad identifier associated to a railroad for which the demurrage charge is to be computed.

33. A computer readable storage medium as described in claim 28, wherein the demurrage charge computation parameters include a railcar type identifier for which the demurrage charge is to be computed.

34. A computer readable storage medium as described in claim 28, wherein the demurrage charge computation parameters include one or more data elements selected from the set consisting of a time indicator data element, railroad identifier and a railcar type identifier.

35. A computer readable storage medium as defined in claim 28, wherein applying the charge policy includes selecting a charge policy from a plurality of charge policies on the basis of railcar characteristics.

36. A computer readable storage medium as defined in claim 34, wherein applying the charge policy includes selecting a charge policy from a plurality of charge policies on the basis of the railroad identifier.

37. A computer readable storage medium as defined in claim 13, wherein the database of railcar events includes a plurality of records, each record being associated to a respective railcar, each record including a plurality of entries associated to the railcar allowing searching records on the basis of the demurrage charge computation parameters.

38. A computer readable storage medium as defined in claim 36, wherein each record includes at least one entry selected from the set consisting of a time indicator data element, a railroad identifier and a railcar type identifier.

39. A computer readable storage medium as defined in claim 36, wherein each record includes at least one time indicator data element indicative of time of entrance of the associated railcar in the private railway site and at least some records include an indicator data element indicative of time of exit of the associated railcar in the private railway site.

40. A browser suitable for execution on a user computer, said browser being suitable for:
a) displaying a user interface including input controls for specifying demurrage charge computation parameters;
b) in response to the user providing the demurrage charge computation parameters with the input controls, transmitting a signal to a server system conveying the demurrage charge computation parameters;
c) in response to receiving a message from the server system including demurrage charge results, displaying a user interface to the user including demurrage charge results.

41. A browser as described in claim 39, wherein the user interface including input controls for specifying demurrage charge computation parameters includes an input control for specifying a time indicator data element.

42. A browser as described in claim 40, wherein the input control for specifying a time indicator data element is in the form of a pull-down calendar allowing a user to specify a beginning date and an end date.

43. A browser as described in claim 39, wherein the user interface including input controls for specifying demurrage charge computation parameters includes an input control for specifying a railroad identifier.

44. A browser as described in claim 42, wherein input control for specifying a railroad identifier is in the form of a list of railroad identifiers allowing the user to select any one of those identifiers as input.

45. A browser as described in claim 39, wherein the user interface including input controls for specifying demurrage charge computation parameters includes an input control for specifying a railcar type identifier.

46. A browser as described in claim 44, wherein input control for specifying a railcar type identifier is in the form of a list of railcar type identifiers allowing the user to select any one of those identifiers as input.

47. A browser as described in claim 39, wherein the user interface including input controls for specifying demurrage charge computation parameters includes one or more input controls for specifying demurrage charge computation parameters selected from the set consisting of a time indicator data element, railroad identifier and a railcar type identifier.

48. A browser as defined in claim 46, wherein the user provides the demurrage charge computation parameters through an input device selected from the group consisting of keyboard, pointing device, touch sensitive surface and a speech recognition unit.

49. An apparatus for computing demurrage charges comprising:
a) means for delivering information to a user for prompting the user to enter demurrage charge computation parameters;
b) search means, responsive the demurrage charge computation parameters, for searching a database of railcar events based on the demurrage charge computation parameters to derive a set of railcar entries;
c) means for applying a charge policy to the set of railcar entries to generate at least one data element indicative of a demurrage charge;
d) means for displaying to the user the at least one data element indicative of the demurrage charge derived in c).

50. A method comprising:
a) delivering information to a user for prompting the user to enter delay selection parameters;
b) searching a database of railcar events to derive a set of railcar identifiers associated to railcars currently in the private railway site;
c) in response to the user providing the delay selection parameters, selecting a subset of railcars from the set of railcars currently in the private railway site at least in part on the basis of the delay selection parameters provided by the user;
d) displaying to the user subset of railcar identifiers associated to the subset of railcars selected in c).

51. A method as defined in claim 55, wherein the delay selection parameters including a demurrage charge amount, said method comprising:
a) applying a charge policy to the railcars currently in the private railway site to derive a set of demurrage charge data elements, each demurrage charge data element being associated to a respective railcar currently in the private railway site;
b) in response to the user providing the delay selection parameters, selecting a subset of railcars from the set of railcars currently in the private railway site on the basis of the set demurrage charge data elements derived in a) and the demurrage charge amount provided by the user.

52. A browser suitable for execution on a user computer, said browser being suitable for:
a) displaying a user interface including input controls for specifying delay selection parameters;
b) in response to the user providing the delay selection parameters with the input controls, transmitting a signal to a server system conveying the delay selection parameters;
c) in response to receiving a message from the server system including railcar identifiers associated to a subset of railcars, displaying a user interface to the user including the railcar identifiers included in the message received from the server system.
